(19) United States
(12) Patent Application Publication
(10) Pub. No.: US 2016/0234528 A1
(43) Pub. Date: Aug. 11, 2016

(54) CARRIAGE OF VIDEO CODING FOR BROWSERS (VCB) VIDEO OVER MPEG-2 TRANSPORT STREAMS

(71) Applicant: ARRIS Enterprises, Inc., Suwanee, GA (US)

(72) Inventor: Mandayam Narasimhan, San Diego, CA (US)

(21) Appl. No.: 15/019,266

(22) Filed: Feb. 9, 2016

Related U.S. Application Data
(60) Provisional application No. 62/113,590, filed on Feb. 9, 2015.

(51) Int. Cl. H04N 19/70; H04N 19/169; H04N 19/68; H04N 19/46

(52) U.S. Cl. CPC H04N 19/70; H04N 19/46; H04N 19/188; H04N 19/68

(57) ABSTRACT

Extensions needed for MPEG-2 systems to transport Video Coding for Browsers (VCB) video are provided that include certain definitions for VCB video that are specific to MPEG-2 systems. The extension parameters specified include framing of VCB pictures in packetized elementary stream (PES) packets and mapping VCB video streams into MPEG-2 transport packets, signaling of VCB streams using a new stream_type and a VCB specific descriptor in the program map table (PMT) to signal application specific parameters as well as transport stream target decoder (T-STD) parameters for various profiles.

### CROSS REFERENCE TO RELATED APPLICATION

This application claims priority under 35 U.S.C. §119(e) from earlier filed U.S. Provisional Application Ser. No. 62/113,590 filed on Feb. 9, 2016 and incorporated herein by reference in its entirety.

### BACKGROUND

1. Technical Field

The present invention relates to updates from the previous MPEG-2 standard to a new MPEG-2 standard to accommodate Video Coding for Browsers (VCBs) that can be used in video broadcast applications.

2. Related Art

The ISO/IEC 14496-31 standard specifies Video Coding for Browsers (VCBs) which can be used for broadcast applications in addition to streaming over the World Wide Web. For both of these applications, the MPEG-2 system (ISO/IEC 13818-1) transport mechanism will be useful as this has been used for transport of numerous video and audio codec's.

The updated ISO/IEC 14496-31, however, will require extensions needed for the transport mechanism used in MPEG-2 to transport VCB video that are specific to the MPEG-2 systems, as well as other parameters to accomplish transport. Accordingly, it is desirable to provide such extensions.

### SUMMARY

Embodiments of the present invention define extensions needed to MPEG-2 systems for transport of VCB video and includes certain definitions for VCB video that are specific to MPEG-2 systems and other parameters. The parameters specified include framing of VCB pictures in (PES) packetized elementary stream packets and mapping VCB video streams into MPEG-2 transport packets, signaling of VCB streams using a new stream_type and a VCB specific descriptor in the program map table (PMT) to signal application specific parameters as well as transport stream target decoder (T-STD) parameters for various profiles.

In a first embodiment, the present invention includes a method for transporting a VCB over an MPEG-2 transport stream that includes: (1) mapping VCB video elementary streams into MPEG-2 transport packets by providing each VCB access unit so that it is framed in a PES packet with individual time stamps for decoding (DTS) and presentation (PTS); and (2) for each of the VCB elementary streams: (a) ordering the VCB access units in the VCB elementary stream in a monotonic display order; (b) including in each of the VCB access units a PES header with the PTS and containing in each PES packet exactly one VCB access unit; (c) setting a stream_id value in the PES header to 0xBD to allow signaling of the PTS and the DTS in the PES header; (d) signaling a VCB video component of a program using a new stream_type in a program map table (PMT); (e) signaling parameters for the VCB video component using a VCB video descriptor to enable high level acquisition of the VCB video; and (f) incrementing the DTS value for successive VCB access units consistent with frame rate signaled in the VCB descriptor.

In a further embodiments of the present invention dealing with descriptors, the method additionally includes: providing in the VCB video descriptor information about what is present in each VCB access unit; and providing in the VCB video descriptor information about the VCB video sequence. The descriptors can include the following: a descriptor tag, a descriptor length, a profile and level, a horizontal size, a vertical size, a maximum bit rate, a maximum buffer size, a fixed frame rate flag, a frame rate and a still mode.

In further embodiments of the present invention dealing with a transport stream target decoder (T-STD), the method includes: providing a T-STD extension for the VCB video elementary stream, wherein the T-STD includes a transport buffer (TB) and a VCB video elementary stream buffer (EB) for decoding each of the VCB elementary video streams, and wherein the T-STD extension includes a TB size (TBS), a rate Rx between the TB and the EB, and the EB size (EBS).

### BRIEF DESCRIPTION OF THE DRAWINGS

Further details of the present invention are explained with the help of the attached drawings in which:

FIG. 1 illustrates components needed to encode and provide the video data in a transport stream according to embodiments of the present invention;

FIG. 2 shows a Table 1 that identifies VCB video descriptors defined for embodiments of the present invention;

FIG. 3 provides a Table 2 that lists examples of typical broadcast frame rates when frame rate is defined using numerator and denominator values (NUM_frame_rate and DEN_frame_rate);

FIG. 4 shows components of a transport stream decoder T-STD system; and

FIG. 5 provides a listing of notations used to describe the Transport Stream system target decoder parameters.

### DETAILED DESCRIPTION

### I. Overview

Embodiments of the present invention define extensions needed to MPEG-2 systems for transport of VCB video and include certain definitions for VCB video that are specific to MPEG-2 systems and other parameters. The parameters specified include framing of VCB pictures in (PES) packetized elementary stream packets and mapping VCB video streams into MPEG-2 transport packets, signaling of VCB streams using a new stream_type and a VCB specific descriptor in the program map table (PMT) to signal application specific parameters and the use of transport stream target decoder (T-STD) parameters for various profiles.

The following references define parameters for VCB that identify extensions needed to MPEG-2 systems for transport of VCB video:

Reference 1:

ISO/IEC 14496-31, Information technology—Coding of audio visual objects, Part 31: Video Coding for Browsers.

Reference 2:

ITU-T Rec H.222.0 (2006)|ISO/IEC 13818-1:2013, Information technology—Generic g of moving pictures and audio information: Systems.

The following definitions are used in the subsequent disclosure:

VCB Video Access Unit:

A frame or picture as defined in reference [1] which includes all the parameters required to decode the access unit and display the decoded data.

VCB Video Elementary Stream:

Video elementary stream consisting of succession of VCB video access units.

VCB Video Sequence:

VCB video elementary stream that starts with a ‘key frame’ as defined in Reference 1 and where all the access units have the same profile/level and video parameters.

VCB Still Picture (System):

Same as VCB video access unit. Note that the VCB still picture is an MPEG-2 system defined function that supports transmission of VCB video access units at a rate much lower than the frame rate where decoders ‘repeat’ decoded pictures at the display frame rate. This is used in applications such as ‘slide show’ and ‘stills with Music’.

### II. Mapping of VCB Access Unit to PES Packets and VCB Transport Constraints

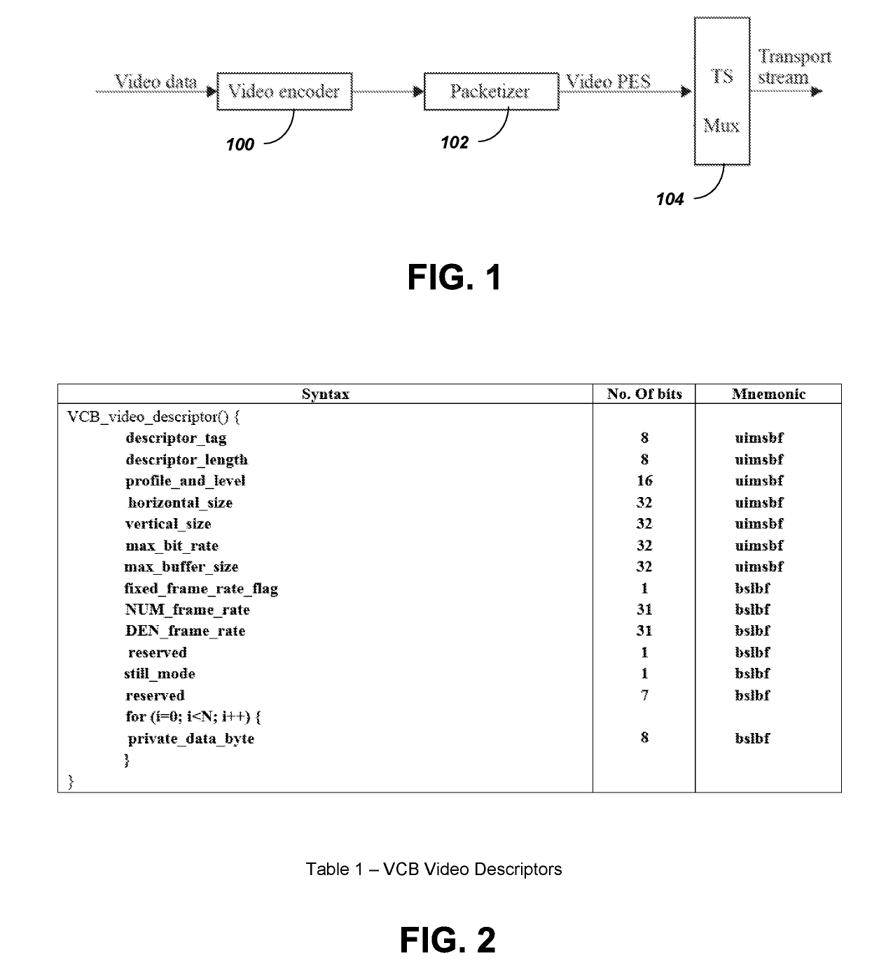

FIG. 1 illustrates components needed to encode and provide the video data in a transport stream. The system includes a video encoder 100 that receives MPEG-2 data, a packetizer 102 that packetizes the video data and creates a packetized elementary stream (PES), and a transport stream multiplexer 104 that takes data from multiple encoders and packetizers and provides the MPEG-2 for transport of VCB video. Although shown as multiple components, the video encoder 100, packetizer 102 and multiplexer 104 can be provided as a single component.

Embodiments of the present invention provide of Mapping of VCB Access Units and VCB transport constraints to enable MPEG-2 systems to transport VCB video. Details of mapping and transport are provided in the following sections.

1. Mapping VCB Access Unit

For embodiments of the present invention, each VCB access unit should be framed in a PES packet along with individual time stamps for decoding and presentation (if they differ) in the packetizer 102 of FIG. 1.

2. VCB Transport

For embodiments of the present invention, once mapped and packetized, when a VCB video elementary stream conforming to one or more profiles as defined in Reference 1, ISO/IEC 14496-31, is transported using MPEG-2 systems, the following rules apply:

(a) The VCB access units shall be ordered in the VCB video elementary stream in a monotonic display order.

(b) Each VCB access unit shall include a PES header with PTS and each PES packet shall contain exactly one VCB access unit.

(c) The Stream_id value in the PES header shall be set to 0xBD (the same as private_stream_1) which allows signaling of PTS and DTS in the PES header.

(d) The VCB video component of a program shall be signaled using a new stream_type (defined by MPEG) in the program map table (PMT).

(e) Parameters for the VCB video component shall be signaled using the VCB video descriptor to enable high level acquisition of VCB video. See the section on VCB video descriptor subsequently for additional information on the VCB video descriptors.

(f) An increment to DTS for successive VCB access units shall be consistent with frame rate signaled in the VCB video descriptor.

(g) The following rule applies to the coding of syntax elements in the adaptation header for transport of the VCB video elementary stream: Both random_access_indicator and elementary_stream_priority_indicator flags can be set to ‘1’ for VCB video access units that are ‘key frames’. Applications may limit the signaling of random access points based on their use cases.

(h) The following rules apply to the coding of syntax elements in the PES header for transport of the VCB video elementary stream: (i) the stream_id shall be set to 0xBD (same as Private_stream_1). (ii) the PES_packet_length shall be set to 0x0000. (iii) data_alignment_indicator shall be set to ‘1’.

3. Interpretation of Flags

For embodiments of the present invention, the interpretation of flags in the adaptation and PES headers for VCB elementary streams is important. The interpretation, extensions, use and constraints for the following syntax elements in the adaptation header and and PES header for VCB video for these embodiments are defined as follows:

(a) in the semantics for discontinuity_indicator, a VCB video elementary stream access point is defined as the first byte of VCB video access unit.

(b) The elementary stream_priority_indicator in adaptation header may be set to ‘1’ if the transport packet payload contains the start of a VCB video access unit that is an I-frame.

(c) For the VCB video elementary streams when the data_alignment_indicator is set to ‘1’ the PES packet header shall be immediately followed by the first byte of VCB video access unit. The data_stream_alignment_descriptor is optional and, if included for VCB video, the alignment_type shall be set to 0x00.

(d) For the VCB video elementary streams conforming to one or more profiles defined in ISO/IEC 14496-31, if a PTS is present in the PES packet header, it shall refer to the first byte of VCB video access unit that commences in this PES packet.

### III. VCB Video Descriptor

For VCB video elementary streams conforming to one or more profiles defined in Annex A of Reference 1, the ISO/IEC 14496-31, the VCB video descriptor provides information that may be present in each VCB access unit as well as for the VCB video sequence. In addition, it provides information to signal VCB still pictures. This descriptor shall be included for each VCB video elementary stream component in the PMT with a new stream_type to be defined by MPEG.

FIG. 2 shows a table 1 that identifies VCB video descriptors defined for embodiments of the present invention, including for each video descriptor the syntax, the number of bits and a mneumonic used for the descriptor. Provided below is more detail describing the syntax including semantics of fields used in the VCB video descriptor.

profile_and_level—This field shall be coded based on the definitions in Annex A of reference 1, ISO/IEC 14496-31, and indicates broadcast profile and level values.

horizontal_size—This field shall be coded based on the parameters defined in Table 2 of reference 1.

vertical_size—This field shall be coded based on the parameters defined in Table 2 of reference 1.

max_bit_rate—This field may be coded based on the profile and level as well as picture sizes by the applications.

max_buffer_size—This field may be coded based on the profile and level as well as picture sizes by the applications.

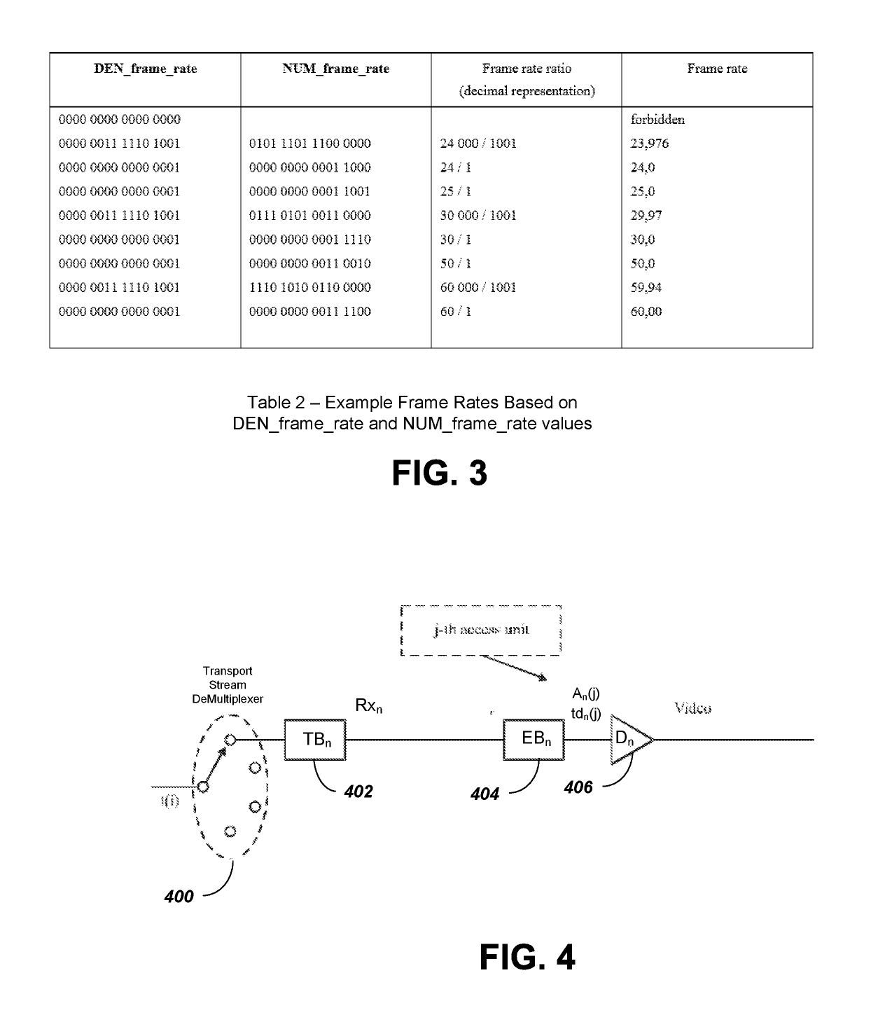

NUM_frame_rate and DEN_frame_rate—These fields shall be coded to signal frames per second using parameters defined in reference 1. FIG. 3 provides a Table 2 that lists examples of typical broadcast frame rates when frame rate is defined using numerator and denominator values (NUM frame rate and DEN frame rate).

still_mode—This 1-bit field when set to ‘1’ indicates that the VCB video stream may include VCB still pictures. When set to ‘0’, then the associated VCB video stream shall not contain VCB still pictures.

### IV. T-STD Extension for VCB Video Elementary Streams

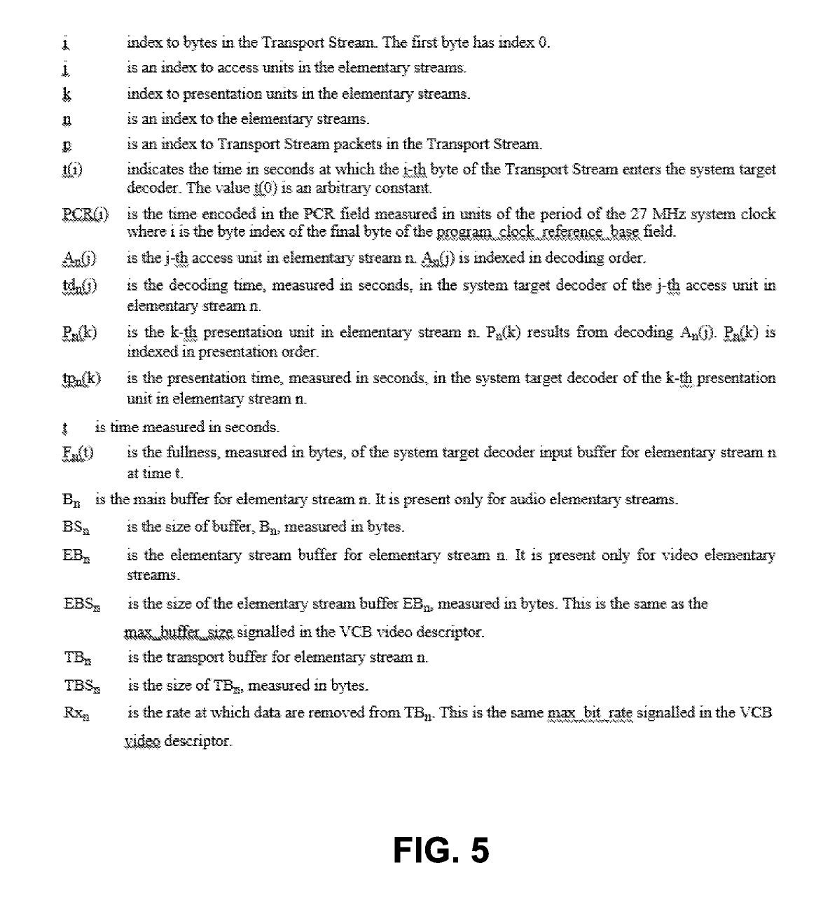

FIG. 4 shows components of a transport stream decoder T-STD system, including a transport stream demultiplexer 400 and decoder components for embodiments of the present invention. For reference, FIG. 5 provides a listing of notations used to describe the Transport Stream system target decoder parameters. The T-STD model decoder components of FIG. 4 include a transport buffer TBₙ 402, a VCB video elementary stream buffer EBₙ 404 and a decoder Dₙ 406 for decoding of each VCB video elementary stream n.

For components shown, like the decoder 406 of FIG. 4 and the encoder 100 of FIG. 1, each component according to embodiments of the present invention can include a processor and memory to enable operation. The memory of each device stores code that is executable by the processor to enable the processor to perform the processes described herein. Further the memory can be used to provide data storage with the data accessible by the processor to store or retrieve when performing operations.

The input to buffer TBₙ and its size TBSₙ are specified in reference 1. The maximum size EBSₙ for buffer EBₙ is based on profile and level of VCB video stream. The rate Rxₙ between TBₙ and buffer EBₙ and the following constraints apply for carriage of VCB video elementary stream:
Rate Rxₙ: when there is no data in TBₙ, then Rxₙ is equal to zero.
Otherwise: Rxₙ=bit rate
where bit_rate is the bit rate is specified for the profile level defined in reference 1. All VCB video payload data bytes enter EBₙ instantaneously upon leaving TBₙ.

Embodiments of the present invention provide for removal of the VCB access units from the EBₙ. For removal, each VCB video access unit Aₙ(j) that is present in EBB is removed instantaneously at decode time tdₙ(j). The decoding time tdₙ(j) is specified by the DTS in the PES header for the VCB video access unit.

System Target Decoders (STD) include the buffers TBn and EBn. Embodiments of the present invention provide for limits on delay through the STD. The total delay of any VCB video elementary stream data other than VCB still picture data through the System Target Decoders buffers TBₙ and EBₙ shall be constrained by tdₙ(j)−t(i)≦1 second for all j, and all bytes i in VCB video access unit Aₙ(j). The delay of any VCB still picture data through the System Target Decoders buffers TBₙ and EBₙ shall be constrained by tdₙ(j)−t(i)≦60 seconds for all j, and all bytes i in VCB video access unit Up:

Embodiments of the present invention also provide for further buffer management conditions. In particular, the transport streams shall be constructed so that the following conditions for buffer management are satisfied: (1) TBₙ shall not overflow and shall be empty at least once every second. (2) EBₙ shall not overflow or underflow. Note that the EBₙ shall not underflow as VCB video elementary streams do not support low delay mode.

Although the present invention has been described above with particularity, this was merely to teach one of ordinary skill in the art how to make and use the invention. Many additional modifications will fall within the scope of the invention as that scope is defined by the following claims.

What is claimed:

1. A method for transport of a VCB video over an MPEG-2 transport stream comprising:
mapping VCB video elementary streams into MPEG-2 transport packets by providing each VCB access unit so that it is framed in a PES packet with individual time stamps for decoding and presentation; and
for each of the VCB elementary streams:
ordering the VCB access units in the VCB elementary stream in a monotonic display order;
including in each of the VCB access units a PES header with PTS and containing in each PES packet exactly one VCB access unit;
setting a stream_id value in the PES header to 0xBD to allow signaling of PTS and DTS in the PES header;
signaling a VCB video component of a program using a new stream_type in a program map table (PMT);
signaling parameters for the VCB video component using a VCB video descriptor to enable high level acquisition of the VCB video; and
incrementing the DTS value for successive ones of the VCB access units consistent with frame rate signaled in the VCB descriptor.

2. The method of claim 1, wherein the VCB video elementary stream comprises a succession of the VCB video access units.

3. The method of claim 1, wherein the video access unit comprises a frame or a picture that includes all the parameters required to decode an access unit and display the decoded data.

4. The method of claim 1, wherein the VCB video elementary stream includes an adaptation header where both random_access_indicator and elementary_stream_priority indicator flags are set to ‘1’ for VCB access units that are key frames.

5. The method of claim 1, wherein the PES header includes:
a stream_id set to a value 0xBD;
a PES_packet_length set to a value 0x0000; and
a data alignment indicator is set to a value “1”.

6. The method of claim 1, wherein the VCB video elementary stream includes an adaptation header with syntax elements, and the PES header includes syntax elements, wherein the adaptation header syntax elements or the PES header syntax elements include:
defining an access point of the VCB video elementary stream as a first byte of the VCB video access unit in the semantics for discontinuity_indicator;
setting to ‘1’ an elementary_stream_priority_indicator in the adaptation header when the transport packet payload contains the start of the VCB video access unit that is an I-frame.
following the PES packet header with first byte of the VCB video access unit in the VCB video elementary stream when a data_alignment_indicator is set to ‘1’; and
referring to the first byte of the VCB video access unit in a PTS of the PES packet header that commences in the PES packet when the PTS is present in the PES packet.

7. The method of claim 1, further comprising:
providing in the VCB video descriptor information about what is present in each VCB access unit; and
providing in the VCB video descriptor information about the VCB video sequence.

8. The method of claim 7, wherein the video descriptor comprises at least one of:
a descriptor tag, a descriptor length, a profile and level, a horizontal size, a vertical size, a maximum bit rate, a maximum buffer size, a fixed frame rate flag, a frame rate and a still mode.

9. The method of claim 1,
wherein the system includes a transport stream target decoder (T-STD) extension for the VCB video elementary stream,
wherein the transport stream target decoder (T-STD) includes a transport buffer (TB) and a VCB video elementary stream buffer (EB) for decoding each of the VCB elementary video streams, and
wherein the T-STD extension includes a TB size (TBS), a rate Rx between the TB and the EB, and the EB size (EBS).

10. The method of claim 9,
wherein each VCB video access unit (A) that is present in the EB is removed at a decoding time (td), and
wherein the decoding time (td) is specified by the DTS in the PES header for the VCB access unit.

11. The method of claim 9,
wherein a total delay of the VCB elementary stream data other than a VCB still picture data through the system target decoder buffers TB and EB is constrained to less than 1 second, and
wherein a total delay of a VCB still picture data through the TB and EB is less than 60 seconds.

12. The method of claim 9,
wherein the TB shall not overflow and shall be emptied at least once every second, and
wherein the EB shall not overflow or underflow.

13. An apparatus encoding, packetizing and preparation of data for transport of a VCB video over an MPEG-2 transport stream, the apparatus comprising a processor and a memory for storing code accessible by a processor to enable the processor to perform operations comprising:
mapping VCB video elementary streams into MPEG-2 transport packets by providing each VCB access unit so that it is framed in a PES packet with individual time stamps for decoding and presentation; and
for each of the VCB elementary streams:
ordering the VCB access units in the VCB elementary stream in a monotonic display order;
including in each of the VCB access units a PES header with PTS and containing in each PES packet exactly one VCB access unit;
setting a stream_id value in the PES header to 0xBD to allow signaling of PTS and DTS in the PES header;
signaling a VCB video component of a program using a new stream_type in a program map table (PMT);
signaling parameters for the VCB video component using a VCB video descriptor to enable high level acquisition of the VCB video; and
incrementing the DTS value for successive ones of the VCB access units consistent with frame rate signaled in the VCB descriptor.

14. The apparatus of claim 13, further comprising a transport stream target decoder (T-STD) for the VCB video elementary stream,
wherein the transport stream target decoder (T-STD) includes a transport buffer (TB) and a VCB video elementary stream buffer (EB) for decoding each of the VCB elementary video streams, and
wherein the T-STD utilizes extensions comprising an TB size (TBS), a rate Rx between the TB and the EB, and the EB size (EBS).

15. The apparatus of claim 14,
wherein each VCB video access unit (A) that is present in the EB is removed at a decoding time (td), and
wherein the decoding time (td) is specified by the DTS in the PES header for the VCB access unit.
